(19) United States
(12) Patent Application Publication
(10) Pub. No.: US 2004/0065070 A1
(43) Pub. Date: Apr. 8, 2004

(54) Crop conditioner roller drive

(76) Inventor: James Thomas Dunn, Winnipeg (CA)

Correspondence Address: ADE & COMPANY, 1700-360 MAIN STREET, WINNIPEG, MB, R3C3Z3, CA

(21) Appl. No.: 10/262,665

(22) Filed: Oct. 2, 2002

(51) Int. Cl. A01D 1/00

(52) U.S. Cl. 56/16.4 B

(57) ABSTRACT

A crop conditioning apparatus includes two parallel fluted intermeshing rollers mounted for rotation about respective axes for passage of crop material therebetween and for movement of the axes in a direction to increase and decrease the spacing the rollers. The rollers and flutes are substantially rigid, such that rotation of the rollers while intermeshing without crop material therebetween and while out of synchronism causes unacceptable noisy contact between the flutes. Each roller being driven by a respective one of two motors arranged to generate substantially equal torque so as to tend to rotate the rollers at common angular velocity. A timing arrangement for maintaining the rollers in synchronism includes a gear wheel having a plurality of gear lobes thereon projecting radially outwardly therefrom on one roller and a disk parallel to the gear wheel with a plurality of rollers projecting outwardly from one face of the disk into a position between the gear lobes of the first member. The gear wheel is formed of a flexible material so that the lobes can flex to an amount such that the intermeshing thereof does not prevent the rollers from relative rotation caused by the presence of crop material therebetween.

This invention relates to a crop conditioning apparatus of the type comprising a pair of parallel meshing fluted rollers between which the crop is directed to pass and particularly to a drive system for synchronous driving of the rollers.

### BACKGROUND OF THE INVENTION

Traditional hay conditioners have two toothed or fluted rolls that intermesh together to crimp the crop as it passes between them. Some rolls are constructed using a steel tube core with a resilient rubber fixed to the outside surface of the tube to form the teeth on the roll. Another construction consists of a steel tube core with steel bars welded on the outside surface of the tube to form the teeth. The rollers are often several feet in length with the flutes extending along the full length often in a spiral pattern so that the flutes or bars on one roller intermesh with those on the other as the rollers rotate. In both constructions, since the teeth or flutes must intermesh during rotation, the two rolls must be timed so that the teeth on each roll do not clash.

It will be appreciated in this regard that the presence of crop tends to hold the teeth apart preventing the front of the bars of one roller impacting the rear of the bars of the other roller and allowing the rollers to run without problems even if slightly out of synchronism. However, when the crop is very light or temporarily absent from between the rotating rollers, the impacting of the teeth or bars as they run slightly out of synchronism generates a noisy action which is unacceptable.

Thus, most conditioners of this rigid type are driven with a mechanical drive driving each of the rolls and this mechanical drive is linked in some way to ensure that the rollers remain properly timed and in synchronism. Various mechanical drives have therefore been designed over the years to ensure synchronous driving action of the steel or rigid rollers but these mechanical drives are complex and prone to wear and thus undesirable. Many attempts have been made to improve the drive but none are entirely satisfactory leaving an outstanding requirement to improve the drive system. One complication is that the drive must accommodate the changing spacing between the rollers, due to the presence of varying amounts of crop material, while maintaining the required synchronism.

There are also some conditioners that use rollers which are wholly or primarily formed of rubber so that there is sufficient flexibility or resilience in the rollers themselves to prevent excessive noise when the rolls are running without crop. However, the necessary resilience of this type of resilient or rubber rollers also provides a reduced crimping action on the crop relative to the preferred rigid or steel rollers and thus the resilient rollers do not themselves resolve the problem since they do not in many cases provide an adequate conditioning action. Such resilient rollers, since they can accommodate engagement of the teeth during rotation without crop, have no synchronism problems and thus can be driven by hydraulic motors, one on each roll with the motors arranged in parallel to provide approximately equal torque. This type of drive has not however been used with rigid or steel rollers since the engagement of the teeth which necessarily occurs when running without crop cannot be tolerated.

### SUMMARY OF THE INVENTION

It is one object of the present invention therefore to provide a drive system for a conditioning apparatus of the type including substantially rigid rollers which provides the necessary synchronism while avoiding the use of complex timed mechanical drives for the rollers.

According to the invention there is provided a crop conditioning apparatus comprising:

first and second generally cylindrical, generally parallel rollers each having on its outer surface a plurality of axially extending flutes;

the rollers being mounted on a support assembly each for rotation about its respective axis for passage of crop material therebetween;

the rollers being mounted on the support assembly for movement of the axes in a direction to increase and decrease the spacing between the outside surfaces of the rollers such that the rollers can move from a minimum spaced position to an increased spaced position in response to the amount of the crop material therebetween;

the flutes being arranged such that the flutes intermesh, at least in the minimum spaced position, as the rollers rotate about their axes for crimping crop material passing therebetween;

each roller being driven by a respective one of two motors arranged to generate substantially equal torque so as to tend to rotate the rollers at common angular velocity;

the rollers and flutes being substantially rigid, such that rotation of the rollers while intermeshing without crop material therebetween and while out of synchronism causes unacceptable noisy contact between the flutes;

and a timing arrangement for maintaining the rollers in synchronism comprising first and second meshing engaging members arranged at one end of the rollers beyond and separate from the flutes, wherein the first member is mounted on the first roller for rotation therewith and the second member is mounted on the second roller for rotation therewith;

the first member having a plurality of projecting elements thereon which intermesh with a plurality of elements of the second member wherein the number of projecting elements is equal to the number of flutes;

the projecting elements being shaped and arranged to maintain the flutes in synchronism while intermeshing without crop material therebetween;

at least the first member being arranged such that the projecting elements thereon can flex when contacted by the projecting elements of the second member.

The flexibility of the projecting elements is such that the projecting elements can flex to an amount greater than the flutes, which are substantially rigid.

Although it is preferred that the only the first member is formed of a flexible material so as to allow flexing of the elements thereof, it is possible also that both the members are to some extent flexible to provide the required flexing action.

The flexing action can be achieved by forming the member itself of a flexible material or by a flexible mounting of the elements on an otherwise rigid structure forming the member itself.

The projecting elements cannot be rigid since this has been found to interfere with the normal operation of the fluted rollers but should flex to an amount such that the intermeshing thereof does not prevent the rollers from relative rotation caused by the presence of crop material therebetween.

In addition or alternatively, the projecting elements may flex to an amount such that the intermeshing thereof does not provide a driving torque between the rollers when the rollers are running with crop material therebetween.

Preferably each projecting element of either the first member or the second member comprises a roller member having an axis of rotation parallel to the axes of rotation of the rollers to accommodate relative sliding movement between the projecting elements when moving into and out of meshing engagement. This is preferably provided by rigid rollers mounted on a rigid second member so that the whole of the flexibility is provided in the first member in the form of the lobed gear wheel. However the rollers can also be flexibly mounted on the disk forming the second member with the flexible mounting of the rollers forming the whole or part of the required flexibility.

Thus it is preferred for simplicity of construction that the first member is formed of a flexible material such that the member can flex to allow flexing of the projecting elements thereof.

Thus it is preferred that the first member comprises a gear wheel in which the projecting elements comprise gear lobes thereon projecting radially outwardly therefrom.

In this arrangement, the second member comprises a disk parallel to the first member and offset to one side of the first member with the projecting elements thereon defined by rollers projecting outwardly from one face of the disk into a position between the gear lobes of the first member.

Preferably the members are arranged on the rollers at an end thereof opposite to the motors.

Thus in general, the device as described in more detail hereinafter consists of a conditioner driven with two hydraulic motors in a parallel hydraulic circuit. The rollers are therefore driven with equal torque to each roller. Without some sort of device to keep the rollers from banging when they run, the conditioner is noisy. Once crop is going through the rollers, the crop keeps the rollers from contacting each other and the rollers run quietly. The timing device is used to keep the teeth or flutes separated each from the next when no crop is in the conditioner. The teeth on the timing device are flexible enough so that they do not drive the rollers when there is crop going through the conditioner but stiff enough that they will prevent the roller teeth from contact when empty. If the rollers separate to pass a slug of material, the teeth may come out of time but will re-time themselves with the teeth of the rollers when the rollers come back together.

The rollers on the one disk of the timing device prevent sliding wear between the top disk and bottom disk.

The tooth profile of the rubber disk or wheel is selected such that the device prevents roller tooth contact at various roller gap settings.

### BRIEF DESCRIPTION OF THE DRAWINGS

One embodiment of the invention will now be described in conjunction with the accompanying drawings in which:

FIG. 1 is a front elevational view of a crop conditioner apparatus according to the present invention.

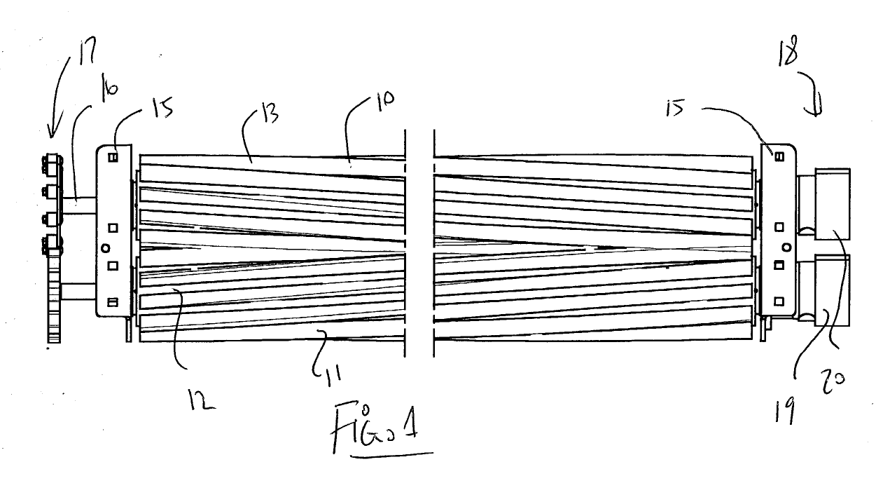

FIG. 2 is an end elevational view showing the timing elements of the apparatus of FIG. 1.

FIG. 3 is an front elevational view on an enlarged scale showing the timing elements of the apparatus of FIG. 1.

In the drawings like characters of reference indicate corresponding parts in the different figures.

### DETAILED DESCRIPTION

The apparatus comprises a pair of conditioner rolls 10 and 11 of a conventional nature which are formed by cylindrical roller surfaces 12 on which are attached flutes or ribs 13. These flutes preferably extend spirally of the rolls so that when they mesh the meshing engagement commences at one end and moves axially along the rollers as the rollers angularly advance. Rollers of this type are well known to one skilled in the art.

The rollers are mounted on suitable mounting arrangements 15 which support the rollers so that they are basically parallel but allow the top roller to move upwardly and downwardly independently at each end in order to accommodate the passage of crop of different thicknesses between the rollers. Again the mounting arrangements are shown only schematically since these are well known to one skilled in the art and many different designs of mounting arrangements can be provided.

Each roller includes a roller shaft 16 which extends along the length of the shaft and passes through bearings in the mounting assembly 15 to a timing device 17 on one end of the rollers and to a drive assembly 18 on the other end of the rollers. The drive assembly comprises a pair of separate hydraulic motors 19 and 20 which are driven by hydraulic supply lines arranged in parallel so that the torque applied to the motors is substantially equal thus tending to drive the motors at a common velocity.

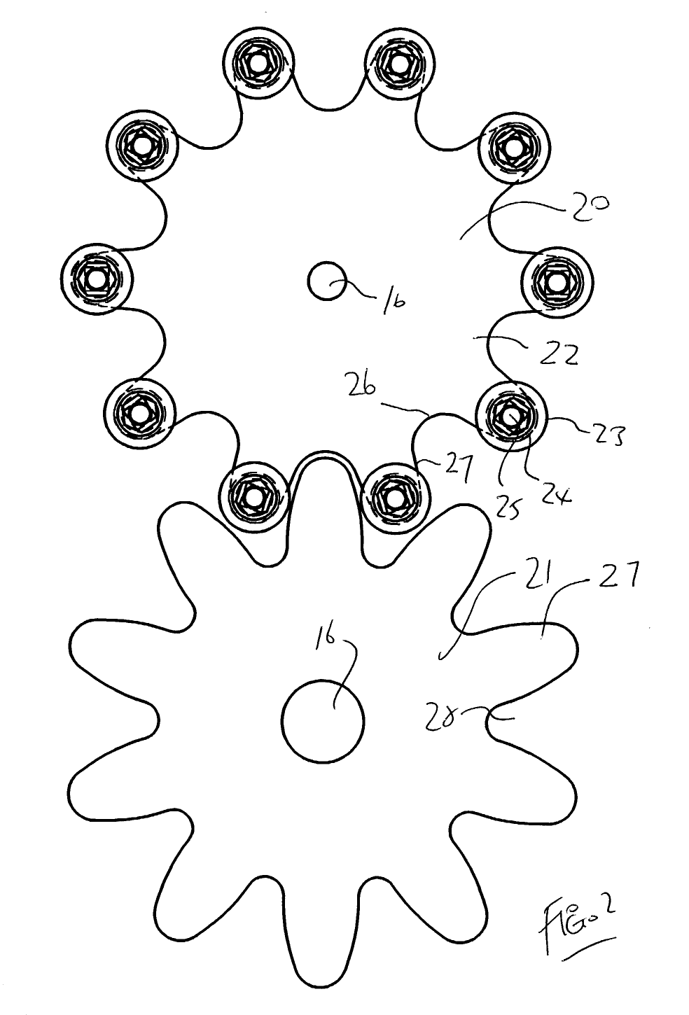

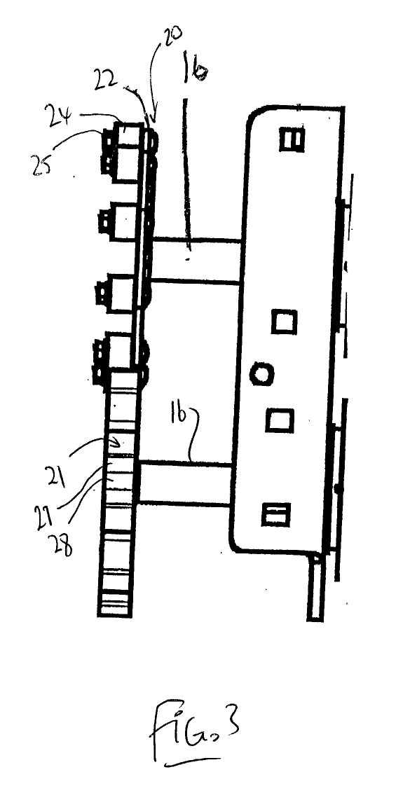

The timing device 17 as best shown in FIGS. 2 and 3 comprises a pair of intermeshing members 20 and 21. One of the members 20 comprises a flat back plate 22 attached to the respective shaft 16. The back plate is formed of flat metal and is therefore rigid and rigidly attached to the shaft 16. The back plate carries a plurality of rollers 23 at angularly spaced positions around the periphery of the back plate with the number of rollers equal to the number of flutes on the roller 10. Each of the rollers 23 is carried on a bearing assembly 24 allowing the roller to rotate around a shaft 25 which is arranged at right angles to the back plate so that it is parallel to the axis of the shaft 16. The back plate is recessed between the rollers as indicated at 26 so that each of the rollers is carried at a lobe 27 of the back plate. The lobe is narrower than the roller so that the roller defines the engagement surfaces at the sides of the lobe.

The second meshing member 21 comprises a lobed gear wheel with a plurality of lobes 27 with recesses 28. The gear wheel 21 is formed of resilient material so that the lobes can flex. The gear wheel may be formed for example of SBR rubber of a suitable hardness which has sufficient flexibility to accommodate the movement necessary during the passing crop to avoid communication of torque through the timing device while maintaining the teeth separate when the crop is absent. The location if the flutes is indicated in dash line F in FIG. 2 showing that the engagement of the rollers with the flexible lobes of the gear wheel hold the flutes separate regardless of the setting of the spacing between the rollers. As shown in FIG. 3 the back plate 20 extends into the lobes of the gear wheel, but instead in an arrangement (not shown) the back plate can be offset to one side thus obviating the necessity for the cut-outs since only the rollers engage into the lobes.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A crop conditioning apparatus comprising:
first and second generally cylindrical, generally parallel rollers each having on its outer surface a plurality of axially extending flutes;
the rollers being mounted on a support assembly each for rotation about its respective axis for passage of crop material therebetween;
the rollers being mounted on the support assembly for movement of the axes in a direction to increase and decrease the spacing between the outside surfaces of the rollers such that the rollers can move from a minimum spaced position to an increased spaced position in response to the amount of the crop material therebetween;
the flutes being arranged such that the flutes intermesh, at least in the minimum spaced position, as the rollers rotate about their axes for crimping crop material passing therebetween;
each roller being driven by a respective one of two motors arranged to generate substantially equal torque so as to tend to rotate the rollers at common angular velocity;
the rollers and flutes being substantially rigid, such that rotation of the rollers while intermeshing without crop material therebetween and while out of synchronism causes unacceptable noisy contact between the flutes;
and a timing arrangement for maintaining the rollers in synchronism comprising first and second meshing engaging members arranged at one end of the rollers beyond and separate from the flutes, wherein the first member is mounted on the first roller for rotation therewith and the second member is mounted on the second roller for rotation therewith;
the first member having a plurality of projecting elements thereon which intermesh with a plurality of elements of the second member wherein the number of projecting elements is equal to the number of flutes;
the projecting elements being shaped and arranged to maintain the flutes in synchronism while intermeshing without crop material therebetween;
at least the first member being arranged such that the projecting elements thereon can flex when contacted by the projecting elements of the second member.

2. The crop conditioning apparatus according to claim 1 wherein the projecting elements of at least the first member can flex to an amount greater than the flutes.

3. The crop conditioning apparatus according to claim 1 wherein the projecting elements of at least the first member can flex to an amount such that the intermeshing thereof does not prevent the rollers from relative rotation caused by the presence of crop material therebetween.

4. The crop conditioning apparatus according to claim 1 wherein the projecting elements of at least the first member can flex to an amount such that the intermeshing thereof does not provide a driving torque between the rollers when the rollers are running with crop material therebetween.

5. The crop conditioning apparatus according to claim 1 wherein each projecting element of either the first member or the second member comprises a roller member having an axis of rotation parallel to the axes of rotation of the rollers to accommodate relative sliding movement between the projecting elements when moving into and out of meshing engagement.

6. The crop conditioning apparatus according to claim 1 wherein each projecting element of the second member comprises a roller member having an axis of rotation parallel to the axis of rotation of the second roller to accommodate relative sliding movement between the projecting elements of the second roller and the projecting elements of the first roller when moving into and out of meshing engagement.

7. The crop conditioning apparatus according to claim 1 wherein the first member is formed of a flexible material such that the member can flex to allow flexing of the projecting elements thereof.

8. The crop conditioning apparatus according to claim 1 wherein the first member comprises a gear wheel in which the projecting elements comprise gear lobes thereon projecting radially outwardly therefrom.

9. The crop conditioning apparatus according to claim 8 wherein the second member comprises a disk parallel to the first member and offset to one side of the first member with the projecting elements thereon defined by rollers projecting outwardly from one face of the disk into a position between the gear lobes of the first member.

10. The crop conditioning apparatus according to claim 1 wherein the members are arranged on the rollers at an end thereof opposite to the motors.

11. A crop conditioning apparatus comprising:
first and second generally cylindrical, generally parallel rollers each having on its outer surface a plurality of axially extending flutes;
the rollers being mounted on a support assembly each for rotation about its respective axis for passage of crop material therebetween;
the rollers being mounted on the support assembly for movement of the axes in a direction to increase and decrease the spacing between the outside surfaces of the rollers such that the rollers can move from a minimum spaced position to an increased spaced position in response to the amount of the crop material therebetween;
the flutes being arranged such that the flutes intermesh, at least in the minimum spaced position, as the rollers rotate about their axes for crimping crop material passing therebetween;
each roller being driven by a respective one of two motors arranged to generate substantially equal torque so as to tend to rotate the rollers at common angular velocity;
the rollers and flutes being substantially rigid, such that rotation of the rollers while intermeshing without crop material therebetween and while out of synchronism causes unacceptable noisy contact between the flutes;
and a timing arrangement for maintaining the rollers in synchronism comprising first and second meshing engaging members arranged at one end of the rollers beyond and separate from the flutes, wherein the first member is mounted on the first roller for rotation therewith and the second member is mounted on the second roller for rotation therewith;
the first member comprising a gear wheel having a plurality of gear lobes thereon projecting radially outwardly therefrom;
the second member comprising a disk parallel to the first member and offset to one side of the first member with a plurality of rollers projecting outwardly from one face of the disk into a position between the gear lobes of the first member;
wherein the number of lobes and rollers is equal to the number of flutes;
the lobes and rollers being shaped and arranged to maintain the flutes in synchronism while intermeshing without crop material therebetween;
the first member being formed of a flexible material.

12. The crop conditioning apparatus according to claim 11 wherein the lobes of at least the first member can flex to an amount greater than the flutes.

13. The crop conditioning apparatus according to claim 11 wherein the lobes of the first member can flex to an amount such that the intermeshing thereof does not prevent the rollers from relative rotation caused by the presence of crop material therebetween.

14. The crop conditioning apparatus according to claim 11 wherein the lobes of the first member can flex to an amount such that the intermeshing thereof does not provide a driving torque between the rollers when the rollers are running with crop material therebetween.

15. The crop conditioning apparatus according to claim 11 wherein the members are arranged on the rollers at an end thereof opposite to the motors.
